(19) United States
(12) Patent Application Publication
(10) Pub. No.: US 2020/0290562 A1
(43) Pub. Date: Sep. 17, 2020

(54) VEHICLE CONTROL DEVICE

(71) Applicant: Takashi Aragai, Aichi (JP)

(72) Inventor: Takashi Aragai, Aichi (JP)

(73) Assignee: NIDEC MOBILITY CORPORATION, Aichi (JP)

(21) Appl. No.: 16/816,613

(22) Filed: Mar. 12, 2020

(30) Foreign Application Priority Data
Mar. 14, 2019 (JP) 2019-047527

(51) Int. Cl. B60R 25/10; H04W 4/40; B60R 25/31; B60R 25/34; G01S 13/931

(52) U.S. Cl. CPC B60R 25/1004; H04W 4/40; G01S 13/931; B60R 25/1003; B60R 25/34; B60R 25/31

(57) ABSTRACT

A vehicle control device performs predetermined control on a vehicle by communicating with a portable device held by a user. The Vehicle control device includes: a living body sensor that detects whether or not a living body is present in the vehicle by acquiring biological information of the living body; an output device that outputs an alarm; and an alarm output determination unit that determines the alarm to be output by the output device by detecting the presence of the living body in the vehicle by the living body sensor and satisfying a predetermined condition for outputting the alarm. When the portable device and the vehicle control device communicate with each other after the alarm is output by the output device, the output device stops outputting the alarm.

### CROSS-REFERENCES TO RELATED APPLICATIONS

This application is based upon and claims the benefit of priority from Japanese Patent Application No. 2019-047527, filed on Mar. 14, 2019; the entire contents of which are incorporated herein by reference.

### FIELD

One or more embodiments of the present invention relates to a vehicle control device.

### BACKGROUND

In the related art, there have been suggested various inventions related to a leaving alarm device on the assumption that a child is left behind in a vehicle.

For example, in a child leaving alarm device described in JP-A-2012-188035, an alarm is implemented on the condition that a child seat is attached to a vehicle and a child seat belt is in a wearing state.

Further, the child leaving alarm device of JP-A-2012-188035 determines a degree of the possibility that the child is left behind from the situation of the vehicle, and implements first alarm means or second alarm means in accordance with the degree of the possibility.

However, the child leaving alarm device of JP-A-2012-188035 selects and implements the alarm means in accordance with the degree of the possibility that the child is left behind. Therefore, in the child leaving alarm device of JP-A-2012-188035, even in a situation where the driver recognizes that the child is in a left-behind state (for example, in a case where the driver leaves the vehicle for a short period of time for errands), that is, even in a situation where the necessity of outputting a leaving alarm is low, an alarm is output when a predetermined alarm condition is satisfied. Further, when an alarm is output, there is a problem that an operation for stopping the alarm is troublesome.

One or more embodiments of the present invention has been made in view of the above-described problems, and an object thereof is to output a preliminary alarm before a formal alarm to prevent an inadvertent formal alarm. In addition, after the alarm is output, the output of the alarm is stopped without performing a troublesome operation.

### SUMMARY

In order to solve the above-described problem, in one or more embodiments of the present invention, there is provided a vehicle control device that performs predetermined control on a vehicle by communicating with a portable device held by a user, the vehicle control device including: a living body sensor that detects whether or not a living body is present in the vehicle by acquiring biological information of the living body; an output device that outputs an alarm; and an alarm output determination unit that determines the alarm to be output by the output device by detecting the presence of the living body in the vehicle by the living body sensor and satisfying a predetermined condition for outputting the alarm, wherein when the portable device and the vehicle control device communicate with each other after the alarm is output by the output device, the output device stops outputting the alarm.

According to one or more embodiments of the invention, a preliminary alarm can be output prior to a formal alarm, and an inadvertent formal alarm can be prevented. After the alarm is output, the output of the alarm can be stopped without a troublesome operation.

### BRIEF DESCRIPTION OF DRAWINGS

FIGS. 1A and 1B are views illustrating a vehicle on which a vehicle-mounted control device according to an embodiment of the invention is installed and a portable device.

FIG. 2 is a block diagram illustrating a functional configuration of a vehicle control system according to the embodiment of the invention.

FIG. 3 is a flowchart illustrating an example of a preliminary alarm according to the embodiment of the invention.

FIG. 4 is a flowchart illustrating an example of a preliminary alarm according to the embodiment of the invention.

FIG. 5 is a flowchart illustrating an example of a formal alarm according to the embodiment of the invention.

FIG. 6 is a flowchart illustrating an example of the preliminary alarm according to the embodiment of the invention.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Hereinafter, an embodiment of the present invention will be described in detail. The same members as those of the above-described embodiment will be given the same reference numerals, and the description thereof will be omitted.

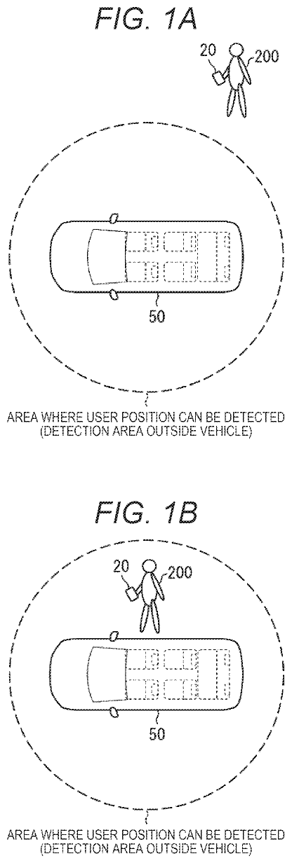

FIGS. 1A and 1B are views illustrating a vehicle 50 on which a vehicle-mounted control device 10 according to an embodiment of the invention is installed and a portable device 20.

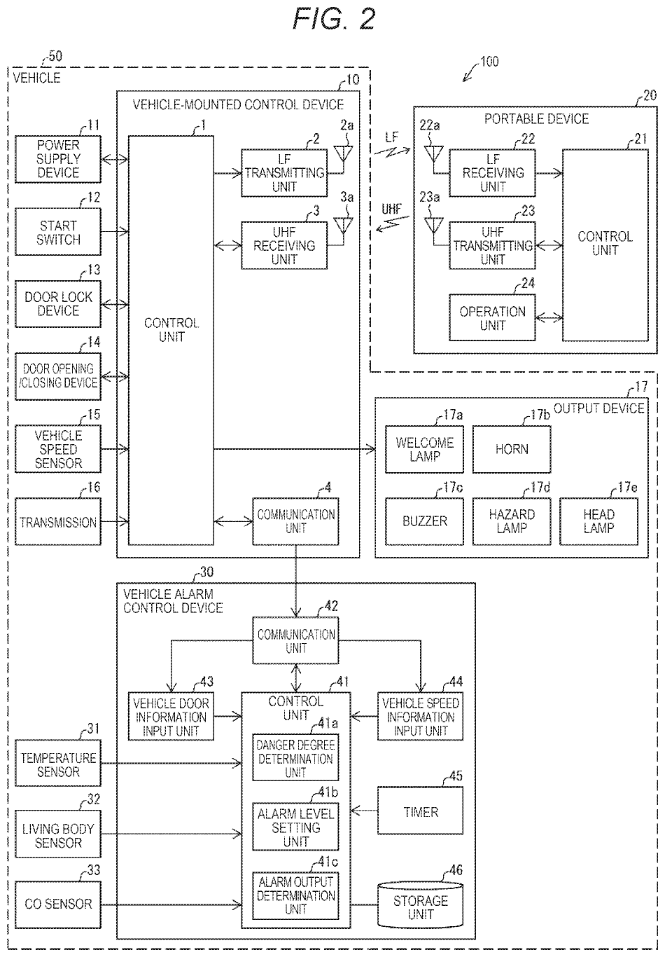

As illustrated in FIG. 2, a vehicle control system 100 includes the vehicle 50 and the portable device 20.

A broken line (illustrated in FIGS. 1A and 1B) that surrounds the vehicle 50 indicates a range in which a radio wave (response request signal) transmitted from an LF transmitting unit 2 (first transmitting unit) included in the vehicle-mounted control device 10 reaches. As illustrated in FIG. 1B, when the portable device 20 of a user 200 of the vehicle 50 enters the range in which the response request signal transmitted from the LF transmitting unit 2 reaches, the response signal is sent to the LF transmitting/receiving unit of the vehicle-mounted control device 10 from the portable device 20. The exchange between the portable device 20 and the vehicle-mounted control device 10 will be described later in detail.

(Schematic Configuration of Vehicle-Mounted Control Device)

As illustrated in FIG. 2, the vehicle-mounted control device 10 includes a control unit 1, an LF transmitting unit 2, a UHF receiving unit 3 (first receiving unit), and a communication unit.

The control unit 1 includes a CPU, a memory, and the like.

The LF transmitting unit 2 includes LF transmitting antennas 2a, a transmission signal processing unit (not illustrated), and the like.

Although not illustrated, the LF transmitting antennas 2a are installed on the right side surface, the left side surface, the rear surface, and the vehicle interior of the vehicle 50.

The LF transmitting unit 2 transmits an LF signal (a signal of an LF band) generated by the transmission signal processing unit to the portable device 20 outside the vehicle or inside the vehicle from the LF transmitting antennas 2a. The LF signal transmitted by the LF transmitting unit 2 includes a response request signal for requesting a response to the portable device 20.

The UHF receiving unit 3 includes a UHF transmitting/receiving antenna 3a, a reception signal processing unit (not illustrated), the transmission signal processing unit (not illustrated), and the like.

The UHF receiving unit 3 receives a UHF signal (a signal of a UHF hand) transmitted from the portable device 20 by the UHF transmitting/receiving antenna 3a and the reception signal processing unit.

In addition, the UHF receiving unit 3 transmits the UHF signal generated by the transmission signal processing unit to the portable device 20 outside the vehicle or inside the vehicle from the UHF transmitting/receiving antenna 3a.

The control unit 1 performs wireless communication with the portable device 20 via the LF transmitting unit 2 and the UHF receiving unit 3, and transmits and receives the LF signal, the UHF signal, and various information to and from the portable device 20.

The communication unit 4 communicates with a communication unit 42 of a vehicle alarm control device 30 by, for example, Car Area Network (CAN).

(Control Target of Vehicle-Mounted Control Device)

The vehicle-mounted control device 10 is connected to each of a power supply device 11, a start switch 12, a door lock device 13, a door opening/closing device 14, a vehicle speed sensor 15, a transmission 16, and an output device 17.

The power supply device 11 is configured with a battery or the like. The power supply device 11 supplies electric power of the battery to each unit of the vehicle 50.

The start switch 12 is installed in the vehicle interior of the vehicle 50. The start switch 12 is operated by the user 200 to drive and stop a traveling driving source of the vehicle 50, and to turn on and off the power. Further, as a power source which is turned on and off by the operation of the start switch 12, there are an ignition (IG) and an accessory (ACC).

The door lock device 13 includes a mechanism for locking and unlocking each door of the vehicle 50, and a driving circuit for the mechanism.

The door opening/closing device 14 includes a mechanism for opening/closing a power sliding door (hereinafter, referred to as “PSD”) of the vehicle 50, and a driving circuit of the mechanism.

The vehicle speed sensor 15 detects the traveling speed of the vehicle 50. The vehicle speed sensor 15 sends the detection result to the control unit of the vehicle-mounted control device 10.

The transmission 16 is a device for optimally switching the rotation of the engine of the vehicle 50 in accordance with the traveling conditions. The control unit of the vehicle-mounted control device 10 (which will be described later) detects the shift position of the transmission 16 by a sensor (not illustrated).

The output device 17 outputs an alarm based on an instruction from the control unit 1. Examples of the output device 17 for outputting the alarm toward the inside of the vehicle include an in-vehicle buzzer (not illustrated), a room lamp (not illustrated), and a speaker (not illustrated) of the car navigation system. Examples of the output device 17 for outputting an alarm toward the outside of the vehicle include a welcome lamp 17a, a horn 17b, a portable device buzzer, a hazard lamp 17d, a head lamp 17e, a warning lamp (not illustrated), and a winker (not illustrated). The output device 17 is connected to the vehicle-mounted control device 10, and the output of the alarm is controlled by the control unit 1. The welcome lamp 17a, the horn 17h, the buzzer 17c, the hazard lamp 17d, the head lamp 17e, and the like are examples of the output device 17, and other vehicle-mounted devices may be used as long as an alarm can be output.

(Configuration of Portable Device)

The portable device 20 includes an electronic key. The portable device 20 includes the control unit 1, an LF receiving unit 22 (second receiving unit), a UHF transmitting unit 23 (second transmitting unit), and an operation unit 24.

Each of the units 21 to 24 of the portable device 20 is operated by electric power of a battery (not illustrated) incorporated in the portable device 20.

The control unit 21 includes a CPU, a memory, and the like.

The LF receiving unit 22 includes an LF receiving antenna 22a, a reception signal processing unit (not illustrated), and the like. The LF receiving unit 22 receives the LF signal transmitted from the vehicle-mounted control device 10 by the LF receiving antenna 22a and the reception signal processing unit. The LF signal received by the LF receiving unit 22 includes a response request signal.

The UHF transmitting unit 23 includes a UHF transmitting/receiving antenna 23a, a transmission signal processing unit (not illustrated), a reception signal processing unit (not illustrated), and the like. The UHF transmitting unit 23 transmits the UHF signal generated by the transmission signal processing unit from the UHF transmitting/receiving antenna 23a to the vehicle-mounted control device 10.

The UHF transmitting unit 23 receives the UHF signal transmitted from the vehicle-mounted control device 10 by the UHF transmitting/receiving antenna 23a and the reception signal processing unit.

The control unit 21 performs wireless communication with the vehicle-mounted control device 10 via the LF receiving unit 22 and the UHF transmitting unit 23, and transmits and receives an LF signal, a UHF signal, and various information to and from the vehicle-mounted control device 10.

The operation unit 24 includes operation keys, a display, and the like. The operation unit 24 is provided with an operation button operated to lock and unlock each door of the vehicle 50, an operation button operated to open and close the PSD, and the like.

(Communication Method Between Vehicle-Mounted Control Device and Portable Device)

The wireless communication method performed between the vehicle-mounted control device 10 and the portable device 20 includes, for example, a passive entry method, a polling method, and a keyless entry method.

(Passive Entry Method)

In the passive entry method, when the user 200 who carries the portable device 20 approaches the vehicle 50 and a passive request switch (not illustrated) installed in the vehicle is turned on, the control unit 1 of the vehicle-mounted control device 10 transmits the response request signal to the portable device 20 through the LF transmitting unit 2. When receiving the response request signal, the portable device 20 returns the response signal to the UHF receiving unit 3 of the vehicle-mounted control device 10 via the UHF transmitting unit 23. Then, when receiving the response signal by the UHF receiving unit 3, the vehicle-mounted control device 10 performs authentication of the portable device 20 based on an ID code of the portable device 20 included in the response signal, and when the authentication is successful, for example, the unlocking or opening operation of the door of the vehicle 50 is executed. Further, locking and closing operations, turning on and off the power of the vehicle 50, driving and stopping of the engine, lighting of lamps, and the like may be performed.

(Polling Method)

In the polling method, regardless of the position of the portable device 20, the control unit 1 of the vehicle-mounted control device 10 intermittently transmits the response request signal to the portable device 20 by the LF transmitting unit 2 at a constant cycle. When receiving the response request signal, the portable device 20 returns the response signal to the UHF receiving unit of the vehicle-mounted control device 10 via the UHF transmitting unit 23. Then, when receiving the response signal by the UHF receiving unit 3, the vehicle-mounted control device 10 performs authentication of the portable device 20 based on the ID code of the portable device 20 included in the response signal, and when the authentication is successful, for example, the unlocking or opening operation of the door of the vehicle 50 is executed. Further, locking and closing operations, turning on and off the power of the vehicle 50, driving and stopping of the engine, lighting of lamps, and the like may be performed.

(Keyless Entry Method)

The keyless entry method is a function of performing remote operation of locking or unlocking of the door of the vehicle 50 by operating the portable device 20 without using a physical key.

More specifically, when the remote operation signal transmitted from the UHF transmitting unit 23 of the portable device 20 is received by the UHF receiving unit 3 of the vehicle-mounted control device 10, the control unit 1 collates the ID of the portable device 20 included in the remote operation signal with the ID of the vehicle-mounted control device 10. When both IDs match each other, the control unit 1 determines that the authentication of the portable device 20 is successful, permits the control of the door lock device 13 based on the remote operation signal, and locks and unlocks the door of the vehicle 50.

(Control Target of Vehicle Alarm Control Device)

As illustrated in FIG. 2, the vehicle alarm control device 30 is connected to each of a temperature sensor 31, a living body sensor 32, and a CO sensor 33.

The temperature sensor 31 is a sensor for detecting the temperature of the inside of the vehicle. The temperature sensor 31 detects the temperature of the inside of the vehicle, but may be a temperature and humidity sensor for detecting temperature and humidity of the inside of the vehicle. In this case, a sensor for detecting humidity is further provided.

The living body sensor 32 is a sensor for detecting a biological signal of an infant who is present in the vehicle. The living body sensor 32 is a non-contact sensor, and detects biological information such as a pulse, respiration, or heartbeat from the movement of the surface of the body of the infant. The detection target of the living body sensor 32 is an infant, but may be another living body, for example, an elementary school student or a person who requires nursing care.

The CO sensor 33 is a sensor for detecting the carbon monoxide concentration in the vehicle.

As the CO sensor 33, there are various methods such as a semiconductor method, a hot wire semiconductor method, a solid electrolyte method, and a constant potential electrolysis method, but any method may be adopted as long as it is possible to detect the carbon monoxide concentration in the vehicle. The CO sensor 33 detects whether or not the carbon monoxide concentration in the vehicle is equal to or higher than a predetermined value.

(Schematic Configuration of Vehicle Alarm Control Device)

The vehicle alarm control device 30 includes a control unit 41, a communication unit 42, a vehicle door information input unit 43, a vehicle speed information input unit 44, a timer 45, and a storage unit 46.

The control unit 41 includes a CPU, a memory, and the like. The control unit 41 includes a danger degree determination unit 41a, an alarm level setting unit 41h, and an alarm output determination unit 41c.

The danger degree determination unit 41a determines whether or not the living body that is present in the vehicle is in a dangerous state. Specifically, the danger degree determination unit 41a determines whether or not the living body that is present in the vehicle is in a dangerous state based on information acquired from each of the living body sensor 32, the temperature sensor 31, and the CO sensor 33, locking/unlocking information acquired by the control unit 1 from the vehicle 50, and information acquired from the timer 45.

The danger degree determination unit 41a acquires a determination reference value from the storage unit 46, and determines the danger degree by comparing the determination reference value with the vital sign detected by the living body sensor 32, the temperature detected by the temperature sensor 31, and the CO concentration detected by the CO sensor 33.

In addition, the danger degree determination unit 41a may determine the danger degree based on a “variation value” indicating how much the vital sign detected from the infant who is present in the vehicle fluctuates compared to the determination reference value. When the danger degree is determined by the danger degree determination unit 41a based on the variation value, for example, a detection result detected when the infant gets on the vehicle 50 may be used as an initial value of the vital sign of the infant who is present in the vehicle. In this case, the initial value is stored in the storage unit 46.

The vital sign of the infant who is present in the vehicle may be acquired at all times from the time when the infant gets on the vehicle 50, or may be acquired intermittently. In the embodiment, an example is given in which the vital sign is acquired from the time when the infant gets on the vehicle, but when the variation value from the determination reference value can be calculated, the vital sign of the infant may be detected at any timing.

(Abnormal Value)

The danger degree determination unit 41a may determine whether or not the living body who is present in the vehicle is in a dangerous state based on whether or not the numerical value detected by the temperature sensor 31 or the CO sensor 33 indicates an abnormal value. Here, the abnormal value of the in-vehicle temperature is a numerical value that exceeds the upper limit or falls below the lower limit of the set value, with reference to the preset set value of the in-vehicle temperature. The abnormal value of the CO concentration is a numerical value that exceeds the upper limit of the set value, with reference to the preset set value of the CO concentration in the vehicle. The set value (abnormal value) is stored in the storage unit.

Here, the abnormal value includes a first abnormal value and a second abnormal value, which is an abnormal value at which the degree of danger to the living body that is present in the vehicle is higher than that of the first abnormal value.

The in-vehicle temperature of the first abnormal value changes depending on the country, region, ambient temperature, season, and the like, and may have a plurality of set values. The set value of the in-vehicle temperature is a value that can be changed.

The CO concentration of the first abnormal value is set with 100 ppm (parts per million) as the upper limit. The upper limit value of 100 ppm is a standard, and the CO concentration may be set to be lower than the upper limit value of 100 ppm.

The second abnormal value is a numerical value at which there is a high possibility that the living body that is present in the vehicle dies. For example, regarding the in-vehicle temperature, the upper limit value is set to 40° C. or higher and the lower limit value is set to 0° C. or lower. Regarding the CO concentration, the upper limit is set to 800 ppm. The set values are examples, and the upper limit value of the in-vehicle temperature may be set to 39° C. or lower and the lower limit value may be set to 3° C. or lower. Regarding the CO concentration, the upper limit may further be reduced to 700 ppm or lower or may be set to other concentrations.

In addition, the danger degree determination unit 41a determines whether or not the living body that is present in the vehicle is in a dangerous state on condition that a predetermined time has elapsed from the time point when it is detected that the living body is present in the vehicle by the living body sensor 32. It is measured whether or not the predetermined time has elapsed by the timer 45.

The alarm level setting unit 41b sets an alarm level based on the determination result of the danger degree determination unit 41a. The alarm levels are divided into levels based on the danger degree, and preliminary alarms and formal alarms that correspond to each alarm level are prepared.

(Preliminary Alarm)

The preliminary alarm is an alarm toward the outside of the vehicle, and is an alarm to the degree that discomfort to the user 200 (driver) of the vehicle 50 outside the vehicle and a third party other than the user 200 around the vehicle 50 is not caused, and to the degree that the user 200 of the vehicle 50 outside the vehicle notices the alarm. The preliminary alarm is an alarm in a case where the danger degree of the infant who is present in the vehicle is lower than that of the formal alarm. The preliminary alarm is, for example, an alarm to the user 200 of the vehicle 50 outside the vehicle by the portable device buzzer of the user 200, the flashing of the welcome lamp 17a, or the like.

When receiving the response signal from the portable device 20 of the user 200 of the vehicle 50, the control unit 1 stops outputting the preliminary alarm from the output device 17. Further, when receiving a door unlock signal from the door opening/closing device 14, the control unit 1 stops outputting the preliminary alarm by the output device 17. Further, in a case where a predetermined time has elapsed from the start of the output of the alarm, the control unit 1 stops outputting the preliminary alarm by the output device 17. It is measured whether or not the predetermined time has elapsed by the timer 45.

(Formal Alarm)

The formal alarm is an alarm toward the outside of the vehicle, and is an alarm to the degree that the user 200 of the vehicle 50 outside the vehicle 50 or a third party who is in the vicinity of the vehicle 50 notices the alarm excellently. The degree that the user or the third party notices the alarm excellently is, for example, a sound volume or a light volume used for a generally known security alarm of the vehicle 50. The formal alarm is an alarm in a case where the danger degree of the infant who is present in the vehicle is higher than that of the preliminary alarm. The formal alarms include the horn 17b, the security siren, the flashing of the hazard lamp 17d, the flashing of the winker lamp, or the flashing of the tail lamp of the vehicle.

When receiving the response signal from the portable device 20 of the user 200 of the vehicle 50, the control unit 1 stops outputting the formal alarm to the output device 17. Further, when receiving the door unlock signal from the door opening/closing device 14, the control unit 1 stops outputting the formal alarm by the output device 17. Further, as a stop condition of the formal alarm, reception of the signal of the “open” of the door by the control unit 41 may be added. As the stop condition of the formal alarm, an operation of a request switch (not illustrated) may be added.

The preliminary alarm may be an alarm toward the inside of the vehicle. The alarm toward the inside of the vehicle is an alarm to the degree that discomfort to the user 200 of the vehicle 50 in the vehicle is not caused, and to the degree that the user 200 notices the alarm. The alarm toward the inside of the vehicle is an alarm toward the outside of the vehicle or an alarm that the danger degree of the infant who is present in the vehicle is lower than that of the formal alarm. The alarm toward the inside of the vehicle outputs an alarm to the user 200 in the vehicle, for example, by an in-vehicle buzzer, flashing of the room lamp, a sound or screen display of a car navigation system, lighting of a warning lamp of an instrument panel, or the like.

The preliminary alarm may be an output of an alarm to a smart phone (portable terminal) held by the user 200 of the vehicle 50. The alarm to the smartphone is an alarm in a case where the danger degree of the infant who is present in the vehicle is higher than that of the alarm toward the inside of the vehicle and the alarm toward the outside of the vehicle, and the danger degree of the infant who is present in the vehicle is lower than that of the formal alarm. The output of the alarm to the smartphone utilizes, for example, the vibration function, the utterance function, the ring tone function, the short message function, or the e-mail function of the smartphone.

The means for outputting the alarm to the smartphone is not limited to the above-described functions, and for example, a configuration may be adopted in which other functions of the smartphone or an application downloaded by the user 200 of the vehicle 50 are used.

Returning to FIG. 2 again, the schematic configuration of the vehicle alarm control device will be described.

The alarm output determination unit 41c determines an alarm that corresponds to the alarm level set by the alarm level setting unit 41b, that is, one of the preliminary alarm and the formal alarm. The alarm output determination unit 41c outputs the determined alarm from the output device 17.

In a case where the alarm that corresponds to the alarm level set by the alarm level setting unit 41h is a preliminary alarm, the alarm is output to the user 200 by, for example, the portable device buzzer of the user 200 or the flashing of the welcome lamp 17a. In a case where the alarm that corresponds to the alarm level set by the alarm level setting unit 41b is a formal alarm, the alarm is output to the user 200 or the third party in the vicinity of the vehicle 50, for example, by the horn 17b, the security siren, the flashing of the hazard lamp 17d, the flashing of the winker lamp, the flashing of the tail lamp, or the like of the vehicle 50.

The alarm output determination unit 41c may output an alarm to a smartphone owned by the user 200 of the vehicle 50. The smartphone is a multi-function mobile phone having functions of a personal computer, a personal digital assistant (FDA, portable information terminal), and the like. In a case where an alarm is configured to be output to the smartphone, the smartphone includes an antenna and performs wireless communication with a communication control unit (not illustrated) of the vehicle alarm control device 30 via the antenna.

Although the smartphone is exemplified, the invention is not limited to the smartphone and may be a tablet terminal or a wristwatch-type wearable terminal. In other words, any portable terminal device having a function capable of performing wireless communication with the communication control unit may be used. The wireless communication may be performed by, for example, Bluetooth (registered trademark), but may be performed by wireless communication such as Wi-Fi (registered trademark).

The communication unit 42 performs communication with the communication unit 4 by, for example, CAN.

The vehicle door information input unit 43 sends a signal (open/close state signal) indicating the open/close state of the vehicle door to the control unit 41. The open/close state signal is output by the vehicle door information input unit based on a signal (vehicle door open/close signal) received by the control unit 1 from a door open/close detecting unit (not illustrated). The vehicle door open/close signal is sent from the control unit 1 to the communication unit 42 via the communication unit 4, and the vehicle door information input unit 43 receives the vehicle door open/close signal from the communication unit 42.

The vehicle speed information input unit 44 sends a signal indicating the vehicle speed to the control unit 41. A signal (vehicle speed signal) indicating the vehicle speed is output from the vehicle speed information input unit 44 based on the detection result of the vehicle speed received by the control unit 1 from the vehicle speed sensor 15. The vehicle speed signal is sent from the control unit 1 to the communication unit 42 via the communication unit 4, and the vehicle speed information input unit 44 receives the vehicle speed signal from the communication unit 42.

The timer 45 is an internal clock of the vehicle alarm control device 30. The tinier 45 counts the output time of the alarm output by the output device 17. When the timer 45 receives a count start signal from the alarm output determination unit 41c, the timer 45 counts the set time for stopping the alarm.

The storage unit 46 stores various information. The storage unit 46 mainly stores a numerical value of a general vital sign of an infant, a temperature within a normal range in a vehicle, and a CO (carbon monoxide) concentration (hereinafter, referred to as a “determination reference value”) within a range that does not pose a danger to the human body. The determination reference values need not be one, and a plurality of determination reference values may be stored based on various information such as season, age, sex, and the like.

The vehicle-mounted control device 10 and the vehicle alarm control device 30 are examples of the “vehicle control device” of one or more embodiments of invention. The vehicle-mounted control device 10 and the vehicle alarm control device 30 may be separate bodies as in the embodiment, or the vehicle control device of one or more embodiments of the invention may be configured by integrating both devices.

(Leaving Determination of Infant in Vehicle)

In the embodiment, the leaving of the infant in the vehicle is determined by the control unit 41 based on the detection result of the getting-off intention, the detection result of the getting-off operation, and the detection result of whether or not the infant is present in the vehicle. At the time of the determination, the control unit 41 performs determination by combining the detection result of the getting-off intention, the detection result of the getting-off operation, and the detection result of whether or not the infant is present in the vehicle.

(Getting-Off Intention)

Here, the presence of the getting-off intention can be detected, for example, because the IG is switched from “ON” to “OFF”. Specifically, when the control unit 1 receives the IG OFF signal from the start switch 12, the control unit 1 sends the IG OFF signal to the communication unit 42 via the communication unit 4. When receiving the IG OFF signal, the communication unit 42 sends the IG OFF signal to the control unit 41, and when receiving the IG OFF signal, the control unit 41 determines that the getting-off intention of the user 200 of the vehicle 50 is present.

Further, the presence of the getting-off intention can be detected, for example, because the vehicle speed becomes “zero”. Specifically, when the control unit 1 receives a vehicle speed zero signal indicating that the vehicle speed is zero from the vehicle speed sensor 15, the control unit 1 sends the vehicle speed zero signal to the communication unit 42 via the communication unit 4. When receiving the vehicle speed zero signal, the communication unit 42 sends the vehicle speed zero signal to the vehicle speed information input unit 44, and the vehicle speed information input unit 44 outputs the vehicle speed signal based on the vehicle speed zero signal and sends the vehicle speed signal to the control unit 41. When receiving the vehicle speed signal, the control unit 41 determines that the vehicle speed of the vehicle 50 is zero. Based on the determination result, the control unit 41 determines that the getting-off intention of the user 200 of the vehicle 50 is present.

The presence of the getting-off intention is, for example, a case where the shift position becomes parking from a position other than parking. Specifically, when the control unit 1 receives a signal (parking signal) for detecting a shift change from the transmission 16 (shift lever) to parking, the control unit 1 sends the parking signal to the communication unit 42 via the communication unit 4. When receiving the parking signal, the communication unit 42 sends the parking signal to the control unit 41, and when receiving the parking signal, the control unit 41 determines that the getting-off intention of the user 200 of the vehicle 50 is present.

Incidentally, the presence or absence of the getting-off intention of the user 200 of the vehicle 50 may be determined by any one of the above-described getting-off intention or by a combination thereof.

(Getting-Off Operation)

Here, the getting-off operation is an operation in which the user 200 changes the door from the “closed” state to the “open” state.

Specifically, when the control unit 1 receives a signal of door opening/closing (door opening/closing signal) from the door open/close detecting unit (not illustrated), the control unit 1 sends the door opening/closing signal to the communication unit 42 via the communication unit 4. When receiving the door opening/closing signal, the communication unit 42 sends the door opening/closing signal to the vehicle door information input unit 43, and the vehicle door information input unit 43 outputs a signal indicating the open/close state to the control unit 41 based on the door opening/closing signal. In a case where the signal indicating the open/close state is a signal indicating “open” of the door, the control unit 41 determines that the getting-off operation of the user 200 of the vehicle 50 is “present”.

(Living Body Detection)

It is determined whether or not an infant is present in the vehicle by the control unit 41 based on the detection result acquired from the living body sensor 32. Specifically, it is detected whether or not a living body is present in the vehicle by sensing in the vehicle by the living body sensor 32, and regarding whether or not the detected living body is an infant, it is determined whether or not the detected living body is an infant by comparing the general biological information of the infant with the biological information detected by the living body sensor 32.

Here, general biological information of the infant is stored in the storage unit 46. At the time of the determination, the control unit 41 acquires the general biological information from the storage unit 46 and compares the acquired biological information with the biological information detected by the living body sensor 32.

In a case where the living body sensor 32 does not detect the biological information in the vehicle, or in a case where the biological information detected by the living body sensor 32 does not match the general biological information of the infant as a result of comparing the biological information detected by the living body sensor 32 with the general biological information of the infant, the control unit 41 determines whether or not an infant is present in the vehicle based on the result of comparison between the biological information detected by the living body sensor 32 and the general biological information of the infant. In a case where the biological information is not detected by the living body sensor 32, the control unit 41 determines that an infant is not present in the vehicle.

In the embodiment, a configuration for determining an infant is described, but the determination target is not limited to an infant and includes at least a living body that cannot avoid a crisis by the own intention thereof.

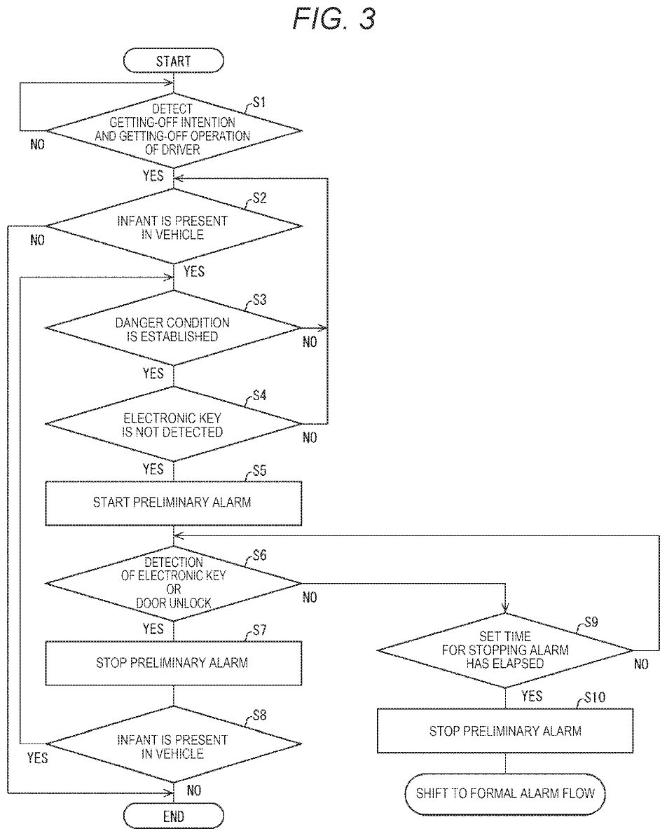

Next, the preliminary alarm and the formal alarm in the embodiment will be described with reference to the flowcharts of FIGS. 3 to 6.

(Preliminary Alarm)

The preliminary alarm is an alarm output prior to the formal alarm.

First, the control unit 41 determines the presence or absence of the getting-off intention of the user 200 of the vehicle 50 (S1). Then, the control unit 41 determines the presence or absence of the getting-off operation of the user 200 of the vehicle 50 (S1).

When it is determined that both the getting-off intention and the getting-off operation of the driver are “absent” (NO in S1), the control unit 41 again determines the presence or absence of the getting-off intention and the getting-off operation of the driver (S1). In addition, even in a case where it is determined that only one of the getting-off intention and the getting-off operation of the driver is “present” (NO in S1), the control unit 41 again determines the presence or absence of the getting-off intention and the getting-off operation of the driver (S1).

Meanwhile, when it is determined that the getting-off intention of the driver is “present” and it is determined that the getting-off operation of the driver is “present” (YES in S1), the control unit 41 determines whether or not an infant is present in the vehicle (S2).

When it is determined that an infant is not present in the vehicle, the control unit 41 stops the operation of the vehicle alarm control device 30 (NO in S2), Meanwhile, when the control unit 41 determines that an infant is present in the vehicle (YES in S2), the control unit 41 determines that the infant who is present in the vehicle is left behind, and causes the danger degree determination unit 41a to determine whether or not the infant who is present in the vehicle is in a dangerous state (S3).

When the danger degree determination unit 41a determines that the infant who is present in the vehicle is not in a dangerous state (NO in S3), the control unit 41 again determines whether or not the infant is present in the vehicle (S2). Meanwhile, when the danger degree determination unit 41a determines that the infant who is present in the vehicle is in a dangerous state (YES in S3), the determination result is sent to the control unit 1 via the communication unit 42 and the communication unit 4, and the control unit 1 that has received the determination result causes the LF transmitting unit 2 to transmit the response request signal (S4). When the portable device 20 of the user 200 of the vehicle 50 receives the response request signal transmitted from the LF transmitting unit 2, the portable device 20 returns the response signal to the vehicle-mounted control device 10. When the vehicle mounted control device 10 receives the response signal from the portable device 20, the control unit 1 performs authentication of the portable device 20 based on the ID code included in the response signal, and when the authentication is successful (NO in S4), the control unit 1 sends the authentication result to the control unit 41 via the communication unit 4 and the communication unit 42, in step S22, the control unit 41 that has received the authentication result again determines whether or not an infant is present in the vehicle (S2).

Meanwhile, when the vehicle-mounted control device 10 cannot receive the response signal from the portable device 20 in response to the response request signal transmitted from the LF transmitting unit 2 (YES in S4), the control unit 1 sends a signal indicating that the portable device cannot be detected to the control unit 41 via the communication unit 4 and the communication unit 42. The control unit 41 that has received the signal sends the determination result by the danger degree determination unit 41a to the alarm level setting unit 41b, and the alarm level setting unit 41b that has received the determination result sets the alarm level to “preliminary alarm” based on the determination result, and sends the setting signal to the alarm output determination unit 41c.

The alarm output determination unit 41c that has received the setting signal from the alarm level setting unit 41b sends an output instruction of “preliminary alarm” to the control unit 1 via the communication unit 42 and the communication unit 4. The control unit 1 that has received the output instruction causes the output device 17 to output an alarm (S5).

When the output device 17 outputs the preliminary alarm, the control unit 1 causes the LF transmitting unit 2 to transmit the response request signal (S6). When the portable device 20 of the user 200 of the vehicle 50 receives the response request signal transmitted from the LF transmitting unit 2, the portable device 20 returns the response signal to the vehicle-mounted control device 10. When the vehicle-mounted control device 10 receives the response signal from the portable device 20, the control unit 1 performs the authentication of the portable device 20 based on the ID code included in the response signal, and when the authentication is successful (YES in S6), the control unit 1 causes the output device 17 to stop the output of the preliminary alarm (S7). The control unit 1 determines the presence or absence of the door unlock signal from the door opening/closing device 14 (S6). When receiving the door unlock signal (YES in S6), the control unit 1 causes the output device 17 to stop the output of the preliminary alarm (S7).

Meanwhile, in the control unit 1, in a case where the vehicle-mounted control device 10 does not receive the response signal from the portable device 20 (NO in S6), a detection disable signal of the portable device 20 is sent to the control unit 41 via the communication unit 4 and the communication unit 42.

When receiving the signal, the control unit 41 determines whether or not a predetermined time has elapsed from the output start time point of the preliminary alarm (S9).

Further, in a case where the door unlock signal is not received (NO in S6), the control unit 1 sends an unreceived signal of the door unlock signal to the control unit 41 via the communication unit 4 and the communication unit 42.

When receiving the signal, the control unit 41 determines whether or not a predetermined time has elapsed from the output start time point of the preliminary alarm (S9).

It is determined whether or not the predetermined time has elapsed based on the information from the timer 45. The timer 45 measures a predetermined time by using the start of the preliminary alarm as a trigger. When the control unit 41 determines that the predetermined time has elapsed based on the information from the timer 45 (YES in S9), a time elapse signal indicating that the predetermined time has elapsed is sent to the control unit 1 via the communication unit 42 and the communication unit 4. The control unit 1 that has received the signal causes the output device 17 to stop the output of the preliminary alarm (S10), and shifts to the formal alarm.

Meanwhile, in a case where the control unit 41 determines that the predetermined time has not elapsed based on the information from the timer 45 (NO in S9), the control unit 41 sends the time elapse signal indicating that the predetermined time has not elapsed to the control unit 1 via the communication unit 42 and the communication unit 4. The control unit 1 that has received the signal again causes the LF transmitting unit 2 to transmit the response request signal (S6), or the control unit 1 determines the presence or absence of the door unlock signal from the door opening/closing device 14 (S6).

In addition, in S4 of the above-described flowchart, in a case where the vehicle-mounted control device 10 cannot receive the response signal from the portable device 20 in response to the response request signal transmitted from the LF transmitting unit 2 (YES in S4), the control unit 1 causes the output device 17 to output the preliminary alarm, but the control unit 1 may postpone the output instruction of the preliminary alarm until a predetermined time elapses from the time point when it is determined that the response signal from the portable device 20 cannot be received. In a case where the control unit 1 is configured to postpone the output instruction of the preliminary alarm, the control unit 1 determines whether or not a predetermined time has elapsed based on the information from the timer 45.

(Formal Alarm)

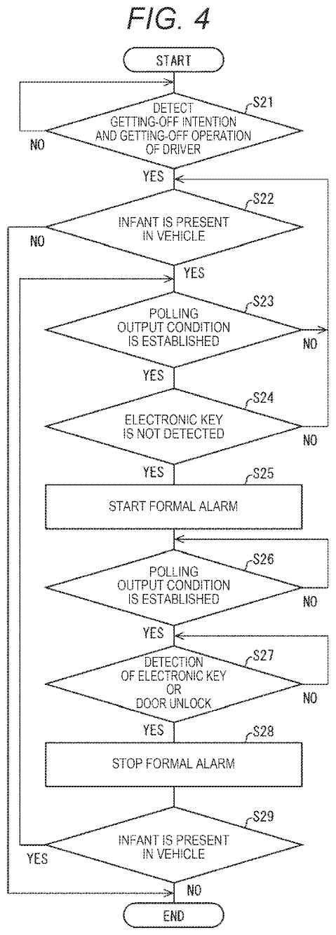

Next, the formal alarm in the embodiment will be described with reference to the flowchart of FIG. 4. Since S21 and S22 in FIG. 4 correspond to S1 and S2 in FIG. 3, respectively, the description thereof will be omitted.

Here, the “polling output condition” illustrated in S23 of FIG. 4 is the same as the condition for the danger degree determination unit 41a to determine the danger degree. In other words, the polling output condition determines whether or not to start the polling output based on whether or not the living body that is present in the vehicle is in a dangerous state.

The polling output transmits a response request signal to the portable device 20 of the user 200 of the vehicle 50. Specifically, the polling output condition satisfies the polling output condition when the living body that is present in the vehicle is in a dangerous state based on the information acquired from each of the living body sensor 32, the temperature sensor 31, and the CO sensor 33, the locking/unlocking information acquired by the control unit 1 from the vehicle 50, and the information acquired from the timer 45. Meanwhile, in a case where the living body that is present in the vehicle is not in a dangerous state, the polling output condition is not satisfied.

In a case where the polling output condition is not satisfied (NO in S23), the control unit 41 again determines whether or not an infant is present in the vehicle (S22). Meanwhile, in a case where the polling output condition is satisfied (YES in S23), the control unit 1 causes the LF transmitting unit 2 to transmit the response request signal (S24). When the portable device 20 of the user 200 of the vehicle 50 receives the response request signal transmitted from the LF transmitting unit 2, the portable device 20 returns the response signal to the vehicle-mounted control device 10. When the vehicle-mounted control device 10 receives the response signal from the portable device 20, the control unit 1 performs authentication of the portable device 20 based on the ID code included in the response signal, and when the authentication is successful (NO in S24), the control unit 1 stops the polling output and sends the authentication result to the control unit 41 via the communication unit 4 and the communication unit 42. The control unit 41 that has received the authentication result again determines whether or not an infant is present in the vehicle (S22).

Meanwhile, when the vehicle-mounted control device 10 cannot receive the response signal from the portable device 20 in response to the response request signal transmitted from the LF transmitting unit 2 (YES in S24), the control unit 1 stops the polling output and sends a signal indicating that the portable device cannot be detected to the control unit 41 via the communication unit 4 and the communication unit 42. The control unit 41 that has received the signal sends the determination result by the danger degree determination unit 41a to the alarm level setting unit 41b, and the alarm level setting unit 41h that has received the determination result sets the alarm level to “formal alarm” based on the determination result, and sends the setting signal to the alarm output determination unit 41c.

The alarm output determination unit 41c that has received the setting signal from the alarm level setting unit 41h sends an output instruction of “formal alarm” to the control unit 1 via the communication unit 42 and the communication unit 4. The control unit 1 that has received the output instruction causes the output device 17 to output an alarm (S25).

After outputting the formal alarm, the control unit 1 determines whether or not the polling output condition is satisfied (S26) After outputting the formal alarm, when it is determined that the polling output condition is not satisfied (NO in S26), the control unit 1 again determines whether or not the polling output condition is satisfied (S26). Meanwhile, after outputting the formal alarm, when it is determined that the polling output condition is satisfied (YES in S26), the control unit 1 causes the LF transmitting unit 2 to transmit the response request signal (S27). When the portable device 20 of the user 200 of the vehicle 50 receives the response request signal transmitted from the LF transmitting unit 2, the portable device 20 returns the response signal to the vehicle-mounted control device 10. When the vehicle-mounted control device 10 receives the response signal from the portable device 20, the control unit 1 performs the authentication of the portable device 20 based on the ID code included in the response signal, and when the authentication is successful (YES in S27), the control unit 1 stops the polling output and causes the output device 17 to stop the output of the formal alarm (S28). The control unit 1 determines the presence or absence of the door unlock signal from the door opening/closing device 14 (S27). When the control unit 1 receives the door unlock signal (YES in S27), the control unit 1 stops the polling output and causes the output device 17 to stop the output of the formal alarm (S28).

Since S29 corresponds to S8 in FIG. 3, the description thereof will be omitted.

In addition, in S24 of the above-described flowchart, in a case where the vehicle-mounted control device 10 cannot receive the response signal from the portable device 20 in response to the response request signal transmitted from the LF transmitting unit 2 (YES in S24), the control unit 1 causes the output device 17 to output the formal alarm, but the control unit 1 may postpone the output instruction of the formal alarm until a predetermined time elapses from the time point when it is determined that the response signal from the portable device 20 cannot be received. In a case where the control unit 1 is configured to postpone the output instruction of the formal alarm, the control unit 1 determines whether or not a predetermined time has elapsed based on the information from the tinier 45.

In addition, in the above-described flowchart S27, when the portable device 20 of the user 200 of the vehicle 50 receives the response request signal transmitted from the LF transmitting unit 2, the portable device 20 returns the response signal to the vehicle-mounted control device 10. When the vehicle-mounted control device 10 receives the response signal from the portable device 20, the control unit 1 performs authentication of the portable device 20 based on the ID code included in the response signal, and after the authentication is successful (YES in S27) or after the door unlock signal is received (YES in S27), a condition in which the control unit 41 receives the signal indicating “open” of the door may further be the stop condition of the formal alarm.

In addition, in the above-described flowchart S27, when the portable device 20 of the user 200 of the vehicle 50 receives the response request signal transmitted from the LF transmitting unit 2, the portable device 20 returns the response signal to the vehicle-mounted control device 10, When the vehicle-mounted control device 10 receives the response signal from the portable device 20, the control unit 1 performs authentication of the portable device 20 based on the ID code included in the response signal, and after the authentication is successful (YES in S27) or after the door unlock signal is received (YES in S27), an ON operation of a request switch (not illustrated) may further be the stop condition of the formal alarm.

In addition, in a case of a situation where the preliminary alarm and the formal alarm are switched to each other in this order, the overlapping steps may be omitted.

### Embodiment 2

Another embodiment of the invention will be described below. For convenience of description, members having the same functions as those described in the above-described embodiment will be given the same reference numerals, and the description thereof will not be repeated.

(Preliminary Alarm)

In the embodiment, the preliminary alarm is different from the preliminary alarm in Embodiment 1 in that the kidnapping alarm is included.

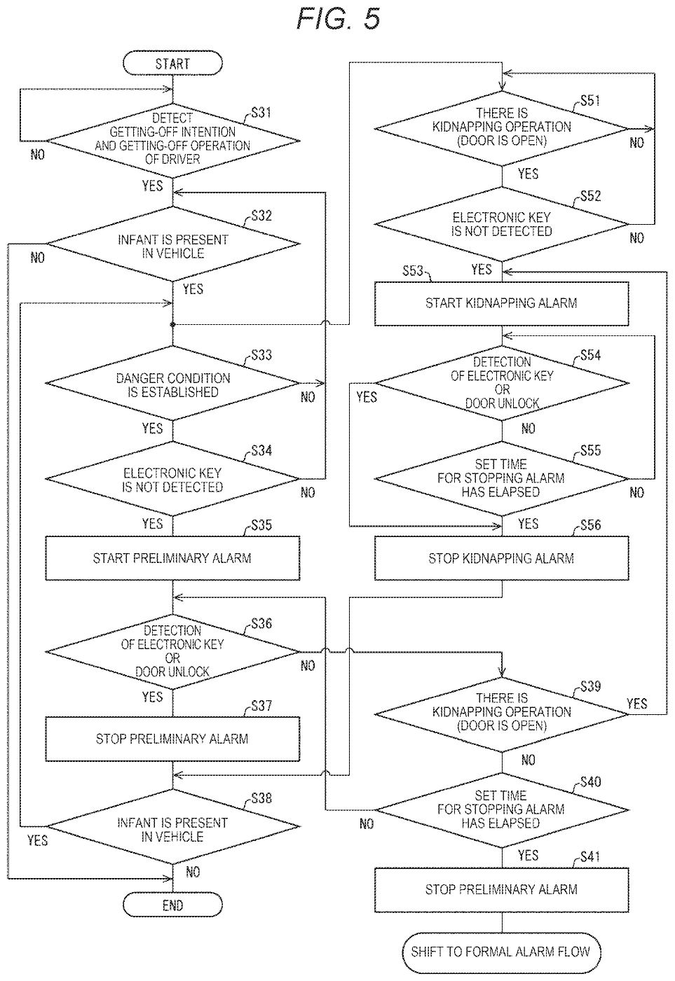

Hereinafter, the description will be made with reference to the flowchart of FIG. 5.

Since S31 to S38 in FIG. 5 correspond to S1 to S8 in FIG. 3, respectively, the description thereof will be omitted.

After the control unit 41 determines that an infant is present in the vehicle (YES in S32), the danger degree determination unit 41a determines whether or not an infant who is present in the vehicle is in a dangerous state (S33), and the presence or absence of a kidnapping operation is also determined (S51). In the embodiment, the “kidnapping operation” means that the door of the vehicle 50 is opened, and the control unit 41 determines that the door is “open” by receiving a signal indicating “open” of the door from the vehicle door information input unit.

When it is determined that the kidnapping operation is “absent” (NO in S51), the control unit 41 again determines the presence or absence of the kidnapping operation (S51). Meanwhile, when the control unit 41 determines that the kidnapping operation is “present” (YES in S51), the determination result is sent to the control unit 1 via the communication unit 42 and the communication unit 4, and when receiving the determination result, the control unit 1 causes the LF transmitting unit 2 to transmit the response request signal (S52). When the portable device 20 of the user 200 of the vehicle 50 receives the response request signal transmitted from the LF transmitting unit 2, the portable device 20 returns the response signal to the vehicle-mounted control device 10. When the vehicle-mounted control device 10 receives the response signal from the portable device 20, the control unit 1 performs authentication of the portable device 20 based on the ID code included in the response signal, and when the authentication is successful (NO in S52), the signal indicating that the detection of the portable device 20 is sent to the control unit 41 via the communication unit 4 and the communication unit 42. The control unit 41 that has received the signal again determines the presence or absence of the kidnapping operation (S51).

Meanwhile, in a case where the vehicle-mounted control device 10 does not receive the response signal from the portable device 20 (YES in S52), the control unit 1 determines that a third party other than the user 200 of the vehicle 50 has opened the door of the vehicle 50, and causes the output device 17 to output the kidnapping alarm (S53).

When the output device 17 outputs the kidnapping alarm, the control unit 1 causes the LF transmitting unit 2 to transmit the response request signal (S54). When the portable device 20 of the user 200 of the vehicle 50 receives the response request signal transmitted from the LF transmitting unit 2, the portable device 20 returns the response signal to the vehicle-mounted control device 10. When the vehicle-mounted control device 10 receives the response signal from the portable device 20, the control unit 1 performs the authentication of the portable device 20 based on the ID code included in the response signal, and when the authentication is successful (YES in S54), the control unit 1 causes the output device 17 to stop the output of the kidnapping alarm (S56). The control unit 1 determines the presence or absence of the door unlock signal from the door opening/closing device 14 (S54). When receiving the door unlock signal (YES in S54), the control unit 1 causes the output device 17 to stop the output of the kidnapping alarm (S56).

After the output of the kidnapping alarm is stopped (S56), the process proceeds to step S38.

Meanwhile, in a case where the vehicle-mounted control device 10 does not receive the response signal from the portable device 20 (NO in S54), the control unit 1 sends a detection disable signal of the portable device 20 to the control unit 41 via the communication unit 4 and the communication unit 42.

When receiving the signal, the control unit 41 determines whether or not a predetermined time has elapsed from the output start time point of the preliminary alarm (S55).

Further, in a case where the control unit 1 does not receive the door unlock signal (NO in S54), an unreceived signal of the door unlock signal is sent to the control unit 41 via the communication unit 4 and the communication unit 42.

When receiving the signal, the control unit 41 determines whether or not a predetermined time has elapsed from the output start time point of the preliminary alarm (S55).

It is determined whether or not the predetermined time has elapsed based on the information from the timer 45. The timer 45 measures a predetermined time by using the start of the kidnapping alarm as a trigger. When it is determined that the predetermined time has elapsed based on the information from the timer 45 (YES in S55), the control unit 41 sends a time elapse signal indicating that the predetermined time has elapsed to the control unit 1 via the communication unit 42 and the communication unit 4. The control unit 1 that has received the signal causes the output device 17 to stop the output of the kidnapping alarm (S56). After the output of the kidnapping alarm is stopped (S56), the process proceeds to step S38.

Meanwhile, in a case where the control unit 41 determines that the predetermined time has not elapsed based on the information from the timer 45 (NO in S55), the control unit 41 sends the time elapse signal indicating that the predetermined time has not elapsed to the control unit 1 via the communication unit 42 and the communication unit 4. The control unit 1 that has received the signal again causes the LF transmitting unit 2 to transmit the response request signal (S54), or the control unit 1 determines the presence or absence of the door unlock signal from the door opening/closing device 14 (S54).

Next, the flowchart from the step S36 of FIG. 5 to the step of outputting the kidnapping alarm will be described.

In step S36, in a case where the vehicle-mounted control device 10 does not receive the response signal from the portable device 20 (NO in S36), the control unit 1 sends a detection disable signal of the portable device 20 to the control unit 41 via the communication unit 4 and the communication unit 42. When receiving the signal, the control unit 41 determines the presence or absence of the kidnapping operation (S39).

Further, in a case where the door unlock signal is not received (NO in S36), the control unit 1 sends an unreceived signal of the door unlock signal to the control unit 41 via, the communication unit 4 and the communication unit 42. When receiving the signal, the control unit 41 determines the presence or absence of the kidnapping operation (S39).

When it is determined that the kidnapping operation is “present” (YES in S39), the control unit 41 sends the determination result to the control unit 1 via the communication unit 42 and the communication unit 4, The control unit 1 that has received the determination result causes the output device 17 to output the kidnapping alarm Since the steps after S53 are the same as those described above, the description thereof will be omitted here.

Meanwhile, when the control unit 41 determines that the kidnapping operation is “absent” (NO in S39), it is determined whether or not a predetermined time has elapsed from the output start time point of the preliminary alarm (S40). It is determined whether or not the predetermined time has elapsed based on the information from the timer 45. The timer 45 measures a predetermined time by using the start of the preliminary alarm as a trigger.

When the control unit 41 determines that the predetermined time has elapsed based on the information from the timer 45 (YES in S40), a time elapse signal indicating that the predetermined time has elapsed is sent to the control unit 1 via the communication unit 42 and the communication unit 4. The control unit 1 that has received the signal causes the output device 17 to stop the output of the preliminary alarm (S41), and shills to the formal alarm.

Meanwhile, in a case where the control unit 41 determines that the predetermined time has not elapsed based on the information from the timer 45 (NO in S40), the control unit 41 sends the time elapse signal indicating that the predetermined time has not elapsed to the control unit 1 via the communication unit 42 and the communication unit 4. The control unit 1 that has received the signal again causes the LF transmitting unit 2 to transmit the response request signal (S36), or the control unit 1 determines the presence or absence of the door unlock signal from the door opening closing device 14 (S36).

(Formal Alarm)

The formal alarm is different from the formal alarm in Embodiment 1 in that the kidnapping alarm is included.

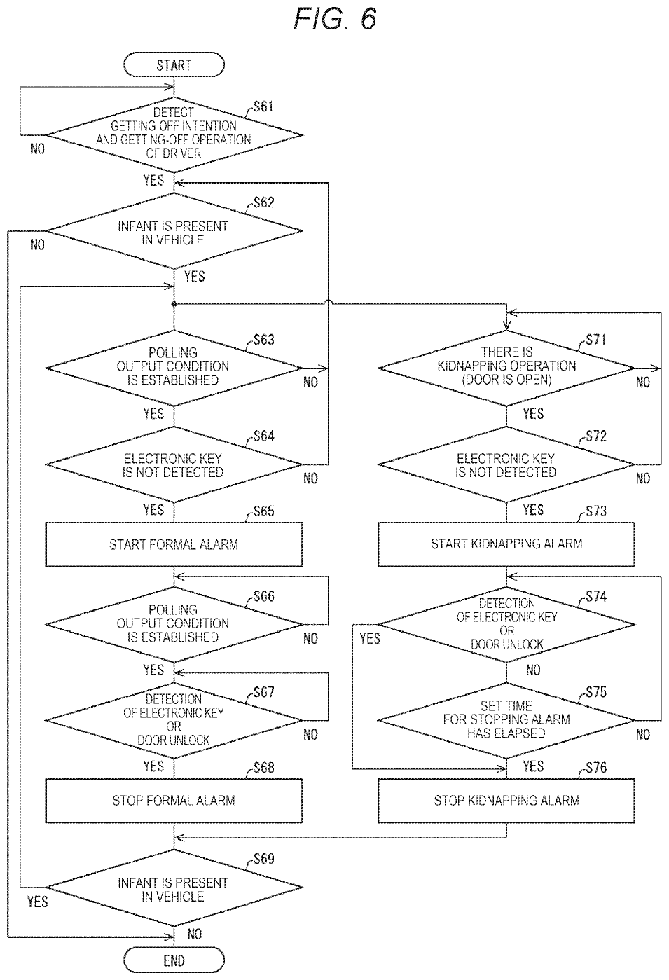

Hereinafter, the description will be made with reference to the flowchart of FIG. 6.

Since S61 to S69 in FIG. 6 correspond to S21 to S29 in FIG. 4, respectively, the description thereof will be omitted.

After determining that an infant is present in the vehicle (YES in S62) until determining whether or not the polling output condition is satisfied (S63), the control unit 41 determines the presence or absence of the kidnapping operation (S71). Since the steps after S71 correspond to the steps after S51 in FIG. 5, the description thereof will be omitted.

Implementation Example by Software

The control blocks of the vehicle alarm control device 30 (in particular, the danger degree determination unit 41a, the alarm level setting unit 41b, and the alarm output determination unit 41c) may be realized by a logic circuit (hardware) formed on an integrated circuit (IC chip) or the like, or may be realized by software.

In the latter case, the vehicle alarm control device 30 includes a computer which executes commands of a program which is software for realizing each function. The computer includes, for example, one or more processors and a computer-readable recording medium in which the program is stored. In the computer, the object of the invention is achieved by reading and executing the program from the recording medium by the processor. The processor may be, for example, a central processing unit (CPU). As the recording medium, tapes, disks, cards, semiconductor memories, programmable logic circuits, and the like can be used in addition to a “non-transitory tangible medium”, for example, a read only memory (ROM) and the like. In addition, a random access memory (RAM) or the like for expanding the programs may further be provided. The program may be supplied to the computer via any transmission medium (communication network or a broadcast wave) capable of transmitting the program. In addition, one or more embodiments of the invention can also be realized in the form of a data signal embedded in a carrier wave in which the program is embodied by electronic transmission.

### SUMMARY

According to Aspect 1 of the invention, there is provided a vehicle control device that performs predetermined control on a vehicle by communicating with the portable device 20 held by the user 200, the vehicle control device including: the living body sensor 32 that detects whether or not the living body is present in the vehicle by acquiring the biological information of the living body; the output device 17 that outputs an alarm; and the alarm output determination unit 41c that determines the alarm to be output by the output device 17 by detecting the presence of the living body in the vehicle by the living body sensor 32 and satisfying a predetermined condition for outputting the alarm, wherein when the portable device 20 and the vehicle control device communicate with each other after the alarm is Output by the output device 17, the output device 17 stops outputting the alarm.

According to the above-described configuration, after detecting whether or not the living body is present in the vehicle, the vehicle control device can output an alarm from the output device 17 by satisfying a predetermined condition. When the portable device 20 and the vehicle control device communicate with each other after the alarm is output by the output device 17, the output device 17 stops outputting the alarm. Accordingly, the user 200 of the vehicle 50 can stop the output of the alarm without performing a troublesome operation after the output of the alarm.

In the vehicle control device according to Aspect 2 of the invention, in the Aspect 1, the vehicle control device may further include the first transmitting unit configured to transmit a response request signal to the portable device; and the first receiving unit configured to receive a response signal from the portable device, the portable device may include the second receiving unit configured to receive the response request signal from the vehicle control device; and the second transmitting unit configured to transmit the response signal to the vehicle control device, and, when the second receiving unit receives the response request signal transmitted from the first transmitting unit, the response signal may be transmitted from the second transmitting unit to the first receiving unit, and when the second receiving unit receives the response signal, the output device may stop outputting the alarm.

According to the above-described configuration, since the output of the alarm can be stopped when the user 200 who holds the portable device 20 returns to the vicinity of the vehicle 50, it is possible to prevent in advance the problem that the alarm cannot be stopped until the actual rescue operation (for example, opening the door) is performed after the alarm is output and causes a trouble to the surroundings.

In the vehicle control device according to Aspect 3 of the invention, in the Aspect 1, the vehicle control device may further include: the first receiving unit configured to receive a remote operation signal from the portable device 20, the portable device may include a second transmitting unit configured to transmit the remote operation signal to the vehicle control device, and when the remote operation signal transmitted from the second transmitting unit is received by the first receiving unit, the output device may stop outputting of the alarm.

According to the above-described configuration, the user 200 can stop the output of the alarm by transmitting the remote operation signal from the portable device 20. Accordingly; it is possible to prevent in advance the problem that the alarm cannot be stopped until the actual rescue operation (for example, opening the door) is performed after the alarm is output and causes a trouble to the surroundings.

In the vehicle control device according to Aspect 4 of the invention, in the Aspect 2, the response request signal to be transmitted from the first transmitting unit may be transmitted after the alarm is output by the output device 17.

According to the above-described configuration, it becomes possible to set the timing of transmitting the response request signal after the output of the alarm. Accordingly, it is possible to suppress battery consumption due to transmission of the response request signal.

In the vehicle control device according to Aspect 5 of the invention, in the Aspect 1, the vehicle control device may further include: the temperature sensor 31 that detects the temperature in the vehicle; and the CO sensor 33 that detects the carbon monoxide concentration in the vehicle, and the predetermined conditions may include at least one of conditions that: the getting-off intention and/or the getting-off operation of the driver is detected; a numerical value detected by the temperature sensor 31 and/or the CO sensor 33 indicates an abnormal value; a vital sign of the living body detected by the living body sensor 32 indicates an abnormal value; and a predetermined time elapses from a time point at which the presence of the living body in the vehicle is detected by the living body sensor 32.

According to the above-described configuration, it is possible to output an alarm by satisfying at least one condition among detecting the getting-off intention and/or the getting-off operation of the driver, indicating an abnormal value as a numerical value detected by the temperature sensor 31 and/or the CO sensor 33, indicating an abnormal value as a vital sign of the living body detected by the living body sensor 32, and elapse of a predetermined time from a time point at which the presence of the living body in the vehicle is detected by the living body sensor 32, or by satisfying a condition in which the plurality of the above-described conditions are combined with each other. Accordingly, it is possible to output an alarm in accordance with the in-vehicle environment and the state of the infant left behind in the vehicle.

In the vehicle control device according to Aspect 6 of the invention, in the Aspect 5, the alarm output determination unit 41c may be configured: to determine the preliminary alarm as an alarm to be output by the output device 17 in a case where the numerical value detected by the temperature sensor 31 and/or the CO sensor 33 indicates the first abnormal value; and to determine the formal alarm as an alarm to be output by the output device 17 in a case where the numerical value detected by the temperature sensor 31 and/or the CO sensor 33 indicates the second abnormal value having a higher degree of danger to the living body than that of the first abnormal value.

According to the above-described configuration, in a case where the numerical value detected by the temperature sensor 31 and/or the CO sensor 33 indicates the second abnormal value having a higher degree of danger to an infant in the vehicle than that of the first abnormal value, it is possible to output the formal alarm that is more easily noticeable to the user 200 of the vehicle 50 and a third part other than the user of the vehicle 50 in the vicinity of the vehicle 50 than the preliminary alarm.

In the vehicle control device according to Aspect 7 of the invention, in the Aspect 2 or 4, the vehicle control device may further include: the vehicle door information input unit to which the information on opening and closing of the door of the vehicle is input, and the vehicle control device may transmit the response request signal from the first transmitting unit to the portable device when the door opening signal is input to the vehicle door information input unit, and the alarm output determination unit may be configured: to determine that the alarm to be output by the output device is a kidnapping alarm when the response signal transmitted from the portable device is not received by the first receiving unit; and not to determine that the alarm to be output by the output device is the kidnapping alarm when the response signal transmitted from the portable device is received by the first receiving unit.

According to the above-described configuration, in a case where the user 200 of the vehicle 50 who has the portable device 20 opens the door of the vehicle 50, an alarm is not output, and on the other hand, when the door of the vehicle 50 is opened by a person who does not have the portable device 20 (a person other than the user 200 of the vehicle 50), an alarm can be output. Accordingly, in a case where the door is opened by a person other than the user 200 of the vehicle 50 who does not have the portable device 20, it is possible to output the kidnapping alarm on the assumption that the infant in the vehicle is kidnapped.

In the vehicle control device according to Aspect 8 of the invention, in any one of Aspects 1 to 7, the living body sensor 32 may detect the biological information by irradiating the living body with a radio wave and receiving a reflected wave from the living body.

According to the above-described configuration, it is possible to detect the presence of the living body in the vehicle interior based on the biological information detected using the radio wave.

Additional Notes

The invention is not limited to the above-described embodiments, and various changes can be made within the scope illustrated in the claims, and embodiments obtained by appropriately combining technical means disclosed in different embodiments are also included in the technical scope of the invention.

1. A vehicle control device that performs predetermined control on a vehicle by communicating with a portable device held by a user, the vehicle control device comprising:
a living body sensor that detects whether or not a living body is present in the vehicle by acquiring biological information of the living body;
an output device that outputs an alarm; and
an alarm output determination unit that determines the alarm to be output by the output device by detecting the presence of the living body in the vehicle by the living body sensor and satisfying a predetermined condition for outputting the alarm,
wherein when the portable device and the vehicle control device communicate with each other after the alarm is output by the output device, the output device stops outputting the alarm.

2. The vehicle control device according to claim 1, further comprising:
a first transmitting unit configured to transmit a response request signal to the portable device; and
a first receiving unit configured to receive a response signal from the portable device,
wherein the portable device comprises:
a second receiving unit configured to receive the response request signal from the vehicle control device; and
a second transmitting unit configured to transmit the response signal to the vehicle control device, and
wherein when the second receiving unit receives the response request signal transmitted from the first transmitting unit, the response signal is transmitted from the second transmitting unit to the first receiving unit, and when the first receiving unit receives the response signal, the output device stops outputting the alarm.

3. The vehicle control device according to claim 1, further comprising:
a first receiving unit configured to receive a remote operation signal from the portable device,
wherein the portable device comprises a second transmitting unit configured to transmit the remote operation signal to the vehicle control device, and
wherein when the remote operation signal transmitted from the second transmitting unit is received by the first receiving unit, the output device stops outputting the alarm.

4. The vehicle control device according to claim 2,
wherein the response request signal to be transmitted from the first transmitting unit is transmitted after the alarm is output by the output device.

5. The vehicle control device according to claim 1, further comprising:
a temperature sensor that detects a temperature in the vehicle; and
a CO sensor that detects a carbon monoxide concentration in the vehicle,
wherein the predetermined condition comprises at least one of conditions that:
a getting-off intention and/or a getting-off operation of a driver is detected;
a numerical value detected by the temperature sensor and/or the CO sensor indicates an abnormal value;
a vital sign of the living body detected by the living body sensor indicates an abnormal value; and
a predetermined time elapses from a time point at which the presence of the living body in the vehicle is detected by the living body sensor.

6. The vehicle control device according to claim 5,
wherein the alarm output determination unit is configured:
to determine a preliminary alarm as the alarm to be output by the output device in a case where the numerical value detected by the temperature sensor and/or the CO sensor indicates a first abnormal value; and
to determine a formal alarm as the alarm to be output by the output device in a case where the numerical value detected by the temperature sensor and/or the CO sensor indicates a second abnormal value having a higher degree of danger to the living body than that of the first abnormal value.

7. The vehicle control device according to claim 2, further comprising:
a vehicle door information input unit to which information on opening and closing of a door of the vehicle is input,
wherein the vehicle control device transmits the response request signal from the first transmitting unit to the portable device when a door opening signal is input to the vehicle door information input unit, and
wherein the alarm output determination unit is configured:
to determine that the alarm to be output by the output device is a kidnapping alarm when the response signal transmitted from the portable device is not received by the first receiving unit, and
not to determine that the alarm to be output by the output device is the kidnapping alarm when the response signal transmitted from the portable device is received by the first receiving unit.

8. The vehicle control device according to claim 1,
wherein the living body sensor detects the biological information by irradiating the living body with a radio wave and receiving a reflected wave from the living body.
